(19) United States
(12) Patent Application Publication
(10) Pub. No.: US 2002/0023124 A1
(43) Pub. Date: Feb. 21, 2002

(54) Method and system for providing character contents in the form of images

(76) Inventor: Fumitaka Murayama, Tajimi-shi (JP)

Correspondence Address: ARMSTRONG, WESTERMAN, HATTORI,, McLELAND & NAUGTON, Suite 1000, 1725 K Street, N.W., Washington, DC, 20006, US

(21) Appl. No.: 09/733,087

(22) Filed: Dec. 11, 2000

(30) Foreign Application Priority Data
Aug. 9, 2000 (JP) 2000-241582

(51) Int. Cl. G06F 15/16; G06F 7/00; G06F 17/00

(52) U.S. Cl. 709/203; 709/246; 707/104.1

(57) ABSTRACT

According to the method for providing character contents, when a request for retrieval is transmitted from a client terminal to a contents providing system through a network, the contents providing system reads the requested character contents by searching storage means. The contents providing system dynamically converts the character contents from character data to image data and transmits the converted image data to the client terminal. The client terminal receives the image data and displays it on a display to allow monitoring of the same. No problem arises in the visibility and readability of the character contents even when they are converted into image data, and a client can use the image data as reference data like character data. On the end of the contents providing system which provides contents, contents are stored in storage means as character data, and the character data are transmitted to the client after being converted into image data while maintaining operability in searching using keywords or the like. This makes it possible to prevent the client from copying and reusing the character data.

### BACKGROUND OF THE INVENTION

1. Field of the Invention

The present invention relates to a method and system for providing character contents from a contents providing system in the form of images to client (user) terminals connected through a network.

2. Description of the Prior Art

For example, publishers who serve various collections of laws, regulations, judicial precedents, etc. have provided such collections to their customers by printing the texts, cases and the like of such laws and regulations on paper and binding them into books. When a user of collections of laws wishes to refer to the particular articles of a certain law or articles associated with a certain subject, the user normally buys a collection of laws which normally consists of many pages and finds out the relevant articles using the collection.

Computers have recently been put in use for operations of printing books and the like, and book publishers now build databases of character information from sentences of books, record the databases in storage apparatuses and read and print character data from the storage apparatuses as needed to make and issue books. Publishers of collections of laws, regulations, judicial precedents and the like also build databases from an enormous amount of character data of the articles and the like to save labor and time required for publishing operations including printing.

When the articles of various laws as described above are recorded in a database as character data, a user can easily search an article of law of interest from using the number of the article, the index of the article or a character string in the article as a keyword. Therefore, publishers of collections of laws, regulations, judicial precedents and the like are now studying the possibility of a system in which a database server storing articles of various laws as character data is connected to a network; requests from user terminals for retrieval of articles and the like are accepted through the network; and the requested articles are provided to the users.

When collections of laws, regulations, judicial precedents and the like are organized into a database and are retrieved in such a manner, a user can retrieve an article of a law or the like of interest and can easily obtain the required article or the like as character data using an information terminal connected to the network. This is very much convenient in that the user can obtain the relevant book much more easily and quickly than actually going to a book store to buy the book or placing an order to a publisher to let them send the book using courier service or the like.

It is advantageous for publishers to provide users with publications such as collections of various laws, regulations and judicial precedents as character data using the internet in that it is possible to save the labor and time required for making books by actually printing characters on paper and for circulating the resultant books to book stores through circulation routes such as wholesalers. However, when character data are transmitted to information terminals of users as they are, a part of a database of books belonging to a publisher is sent as it is to the information terminals of users.

As a result, when such transmission and reception of character data is repeated, a database of books which is a property of a publisher is acquired by information terminals of users in a manner such that it can be completely searched using keywords. When a database similar to that of a publisher is acquired by users, a problem arises in that the value of the database of the publisher as a property is significantly reduced.

### SUMMARY OF THE INVENTION

It is an object of the invention to provide a method and system for providing character contents in the form of images in response to requests for retrieval from users without reducing the value of the database at the provider as a property.

In order to achieve the above-described object, according to the present invention, there is provided a method of providing character contents in which a character contents providing system accepts a request for retrieval of character contents from a client terminal connected to the same system to be able to communicate therewith through a network, reads the character contents from storage means for storing character contents as character data in response to the request for retrieval, dynamically converts them into image data and transmits the data to the client terminal, characterized in that it includes a first step of transmitting the request for retrieval of the character contents from the client terminal to the contents providing system, a second step of searching the storage means of the contents providing system to read the requested character contents, a third step of converting the read character contents from character data to image data, and a fourth step of transmitting the image data as a result of the conversion of the character contents to the client terminal.

In this specification, for example, “image data” is a concept that implies data representing the states, e.g., density and color of each pixel forming a part of an image in a format according to BMP, GIF, JPEG or the like, data obtained by compressing the same, data obtained by encoding the same and vector data and raster data such as CAD data. “Character data” is a concept that implies character data of each character, text data which are combinations of such character data, formatted data for printing and display according to HTML, XML, SGML, PostScript and PDF and data such as encoded character data in a format which allows a client to reuse the data as it is or by performing a certain process on the same as meaningful data.

According to the above-described method for providing character contents, when a request for retrieval of character contents is transmitted from a client terminal to the contents providing system through a network, the contents providing system searches the storage means to read the requested character contents. The contents providing system converts the character contents from character data to image data and transmits the converted image data to the client terminal.

While the client terminal receives the transmitted image data and displays it on a display to allow the user to look at it, no problem occurs in the visibility and readability of the character contents even after they are converted into image data, and the client can preferably use the image data as reference data. On the end of the contents providing system, since contents are stored in the storage means as character data to maintain operability in searching using keywords and the like and the character data are transmitted to clients after being converted into image data, it is possible to prevent clients from copying and reusing the character data and to thereby prevent any reduction of the value of the database as a property.

### BRIEF DESCRIPTION OF THE DRAWINGS

FIG. 1 is a general configuration diagram of a system which represents an embodiment of the invention.

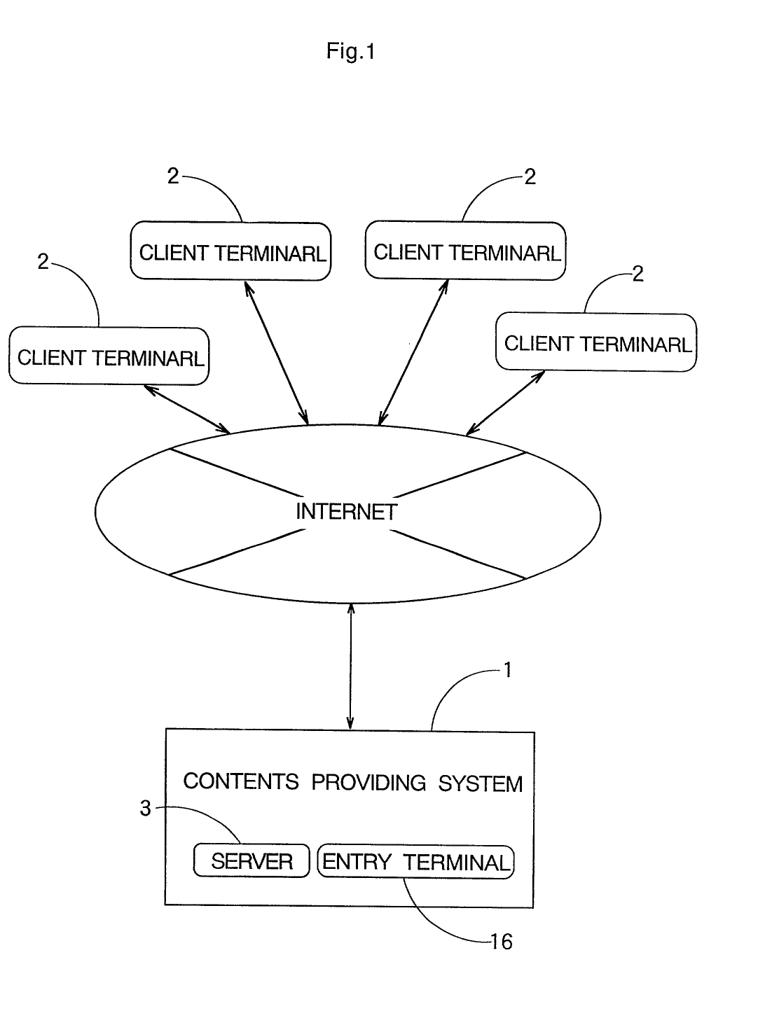

FIG. 2 is a configuration block diagram of a contents providing system.

FIG. 3 is a flow chart showing a process performed by the contents providing system in response to a request for retrieval.

FIG. 4 is an illustration of a screen for inputting a request for retrieval.

### DESCRIPTION OF THE PREFERRED EMBODIMENT

An embodiment of the invent ion will now be described with reference to the drawings. Fi g. 1 shows a general configuration of a character contents providing system. A contents providing system 1 is a system which has a database of character contents, retrieves character contents such as an article of a law requested by a client, converts the same into image data and distributes the data to a client terminal 2 and which is installed at a particular location.

The contents providing system 1 has a server 3 connected to the internet, and the server 3 has a database in which, for example, articles of collections of various laws are stored as character data and transmission means or the like which transmits character contents read from the database or contents such as an article of a law requested by a client to the client terminal 2. The server 3 of the contents providing system 1 is connected to the internet through a dedicated line, telephone line, etc. and runs a homepage on the internet to accept requests for retrieval of character contents from a great number of client terminals 2 that spread over various locations.

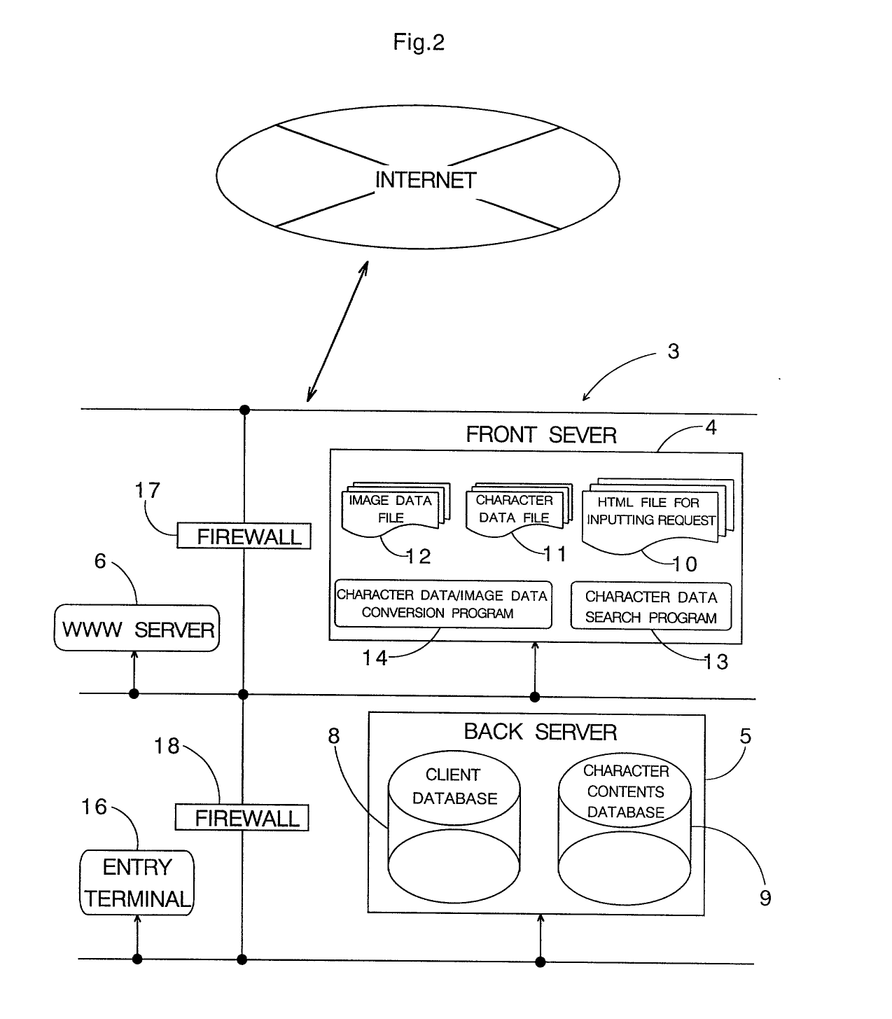

As shown in FIG. 2, the server 3 is constituted by a WWW server (HTTP server) 6 for performing operations such as acceptance of information of retrieval requests and the like sent over the internet and distribution of contents information, a front server 4 for performing processes such as a process of maintaining or creating an HTML file 10 for inputting requests and a process of converting character data such as articles of laws read by searching the database into image data as needed and a back server 5 which is connected behind the front server 4 and which has a database, the back server 5 exchanging information with the front server 4. The front server 4 operates in conjunction with the WWW server 6 acting as an internet communication server to perform a process of transmitting and receiving various types of information through the internet.

The front server 4 has a character data search program 13 which performs a process of transmitting the HTML file 10 for inputting requests through the WWW server 6 when there is access from a client server 2 to make a request for retrieval and a character data/image data conversion program 14 for dynamically converting character data acquired as a result of a search into image data.

Further, the front server 4 has determination means for determining whether the character data of character contents read from a character contents database 9 must be converted into image data when the character data are converted into image data. The above-described character data/image data conversion program 14 converts only character data determined to be converted by the determination means into image data. The front server 4 performs a process of creating an image data file 12 for converted image data, creating a character data file 11 for unconverted character data to allow it to be used as it is and transmitting them to the WWW server 6.

As shown in FIG. 2, the back server 5 acts as a database server and has a client database 8 in which information associated with clients is stored and a character contents database 9 in which important character contents, e.g., character contents such as collections of various laws, regulations and judicial precedents are stored as character data. The back server 5 is disposed such that two firewalls 17 and 18 are interposed between the internet and itself and such that it is located behind the front server 4 in order to maintain the important data with safety by preventing illegal access to such as hacking through the internet.

Information regarding members of the system who are the clients is stored in the client database 8. The identification numbers, names, addresses, ages and E-mail addresses of the members as well as ID codes and passwords assigned to the members are stored. For example, character contents such as collections of various laws, regulations and judicial precedents are stored in the character contents database 9 as character data, and they are stored such that they can be searched using article numbers of the laws or keywords. An entry terminal 16 is provided to allow various items of data in the databases to be changed or updated.

The client terminal 2 is installed at any location such as the home of each client. The client terminal 2 is basically constituted by a personal computer or the like and is connected to the internet through a telephone line or the like, and it has a function of communicating over a communication line and a browser function. For example, when a client wishes to acquire an article of a certain law having an article number of interest or contents such as an article of a law including an arbitrary keyword, the client accesses the homepage of the contents providing system 1 through the client server 2 to receive an article search screen and transmits a request for retrieval by inputting entries required for a search.

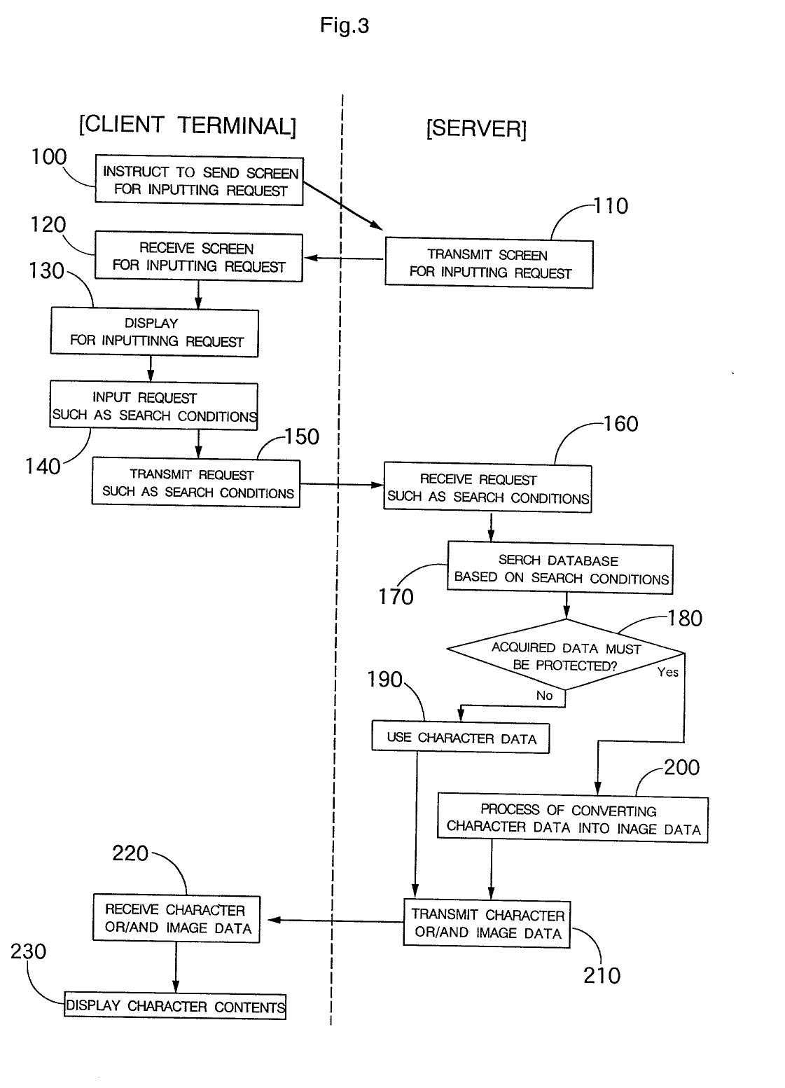

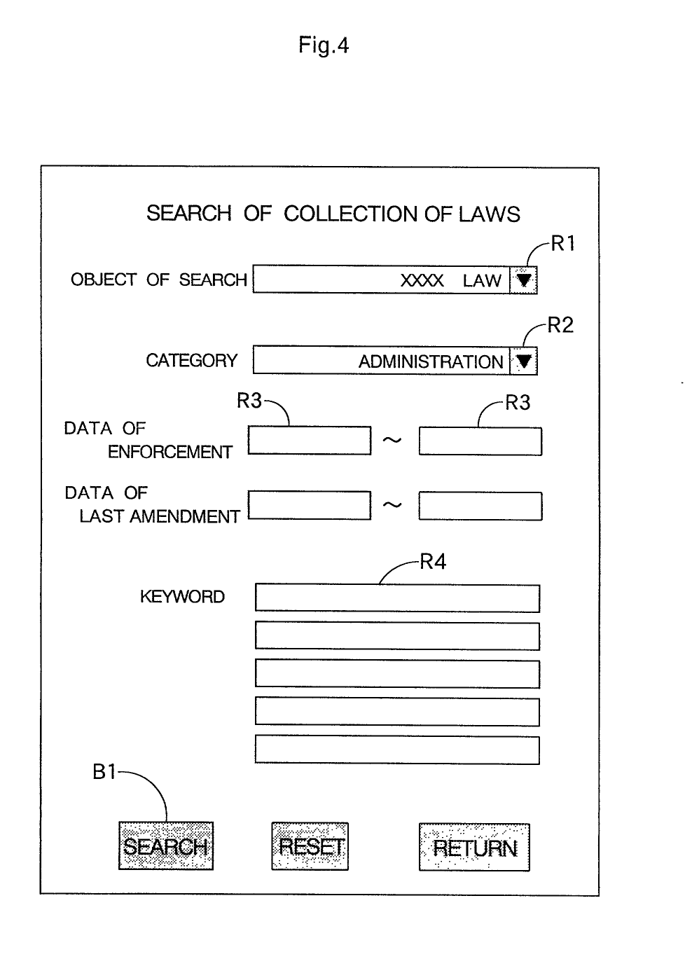

The operation of the character contents providing system will now be described with reference to the flow chart in FIG. 3 and the illustration of a screen in FIG. 4. While a service can be provided in which a registration system is employed to limit clients allowed to access the site of the contents providing system 1 and to provide contents only to registered members, the system may be opened for common people as clients without employing such a registration system.

When a client registration system is employed, a screen for member registration may be prepared on the homepage of the site provided by the contents providing system 1, and the registration screen may be transmitted to a client terminal 2 if the client who has made access wishes to be registered as a member. When the client inputs information required for registration of membership such as the name, address, age and E-mail address of the client on the registration screen and transmits it to the server 3, the WWW server 6 of the server 3 receives the information and transmits the same to the client database 8 to make registration of membership, transmits and assigns an ID number and a password to the client and authorize login using the ID number and password in the case of a request for retrieval.

When a request for a input screen for searching contents is transmitted on a menu screen or the like which is not shown after a client accesses and logs in the contents providing system 1 using the client terminal 2 (step 100 in FIG. 3), the WWW server 6 receives a signal indicating the request for retrieval and transmits a screen for inputting requests as shown in FIG. 4 to the client terminal 2 (step 110).

Upon receipt of the request input screen (step 120), the client terminal 2 displays the screen on a display of the terminal (step 130). For example, when searching of an article in a collection of laws is to be requested, a search request input screen as shown in FIG. 4 is displayed. A column R1 for inputting the object to be searched, a column R2 for inputting the category, a column R3 for inputting the date of enforcement, a column R4 for inputting the keyword, etc. are provided on the search request screen. The client inputs entries required for a search such as the name of the law to be searched, the category of the same, the date of enforcement, the keyword, etc. in the respective input columns R1 through R4 on the screen (step 14) and clicks a “search ” button B1 with those entries input. Then, those conditions for a search are transmitted from the client terminal 2 to the server 3 (step 150) and are received by the WWW server 6 of the server 3 (step 160).

Upon receipt of the searching conditions, the WWW server 6 of the server 3 transmits the same to the front server 4, the character data search program 13 then searches the character contents database 9 (step 170) to read relevant character contents, e.g., an article of a certain law having a certain article number. The read character contents are subjected to determination at the front server 4 on whether the contents are to be converted into image data or not (step 180). In the case of character contents which are not required to be converted into image data, they are directly used to create a character data file 11 at step 190. In the case of character contents which must be converted into image data, at step 200, the character data of the character contents are dynamically converted into image data to create an image data file 12. For example, character contents (character data) such as an article number, index, data of enforcement of an article of a law and the like are regarded as character data which are not required to be converted into image data, and character data such as an article itself are dynamically converted into image data as character data which must be converted into image data.

Contents information which is a combination of such a character data file and image data file is transmitted from the front server 4 of the server 3 to the client terminal 2 through the WWW server 6 (step 210), and the contents information is received by the client terminal 2(step 220) to be displayed on the display (step 230).

As described above, when a client requests the contents providing system to search character contents of interest, the back server 5 of the server 3 of the contents providing system 1 searches the database 9 to read the relevant character contents. The retrieved character contents (character data) are transmitted to the client server 2 as they are if the contents are not required to be converted into image data, and the contents are transmitted after being dynamically converted into image data if they are character data to be converted into image data.

No problem arises in the visibility and readability of character contents even when they are converted from character data to image data if the contents are character information such as articles of various laws, and a client can easily read them and use them effectively. When the character contents are an article of a law as described above, since additional data other than the article itself such as the article number, index and data of enforcement of the article are transmitted as it is as character data which are not required to be converted into image data, it is possible to limit the amount of image data to a required minimum, thereby minimizing the amount of data to be transmitted.

Thus, the server can prevent character data itself from being passed over to a client while maintaining the operability in searching and reading character strings at the client at a level similar to that of normal character data. Since a required part of character contents are provided to a client after being converted into image data, it is possible to prevent a part or entirety of, for example, a database of books possessed by a publisher from being transmitted to the terminal of a client as it is, thereby preventing any reduction of the value of a database of books of a publisher or the like as a property.

Further, only character contents (character data) are stored in the database, and character data which must be converted into image data among character contents searched and read are dynamically converted into image data and transmitted. Therefore, the database is required only to store character data and manage changes and the like to them, and there is no need for building databases for both of character data and image data.

When the character data of entire character contents are to be used by converting it into image data in advance, e.g., when image data are created for each page, data can be provided only on a page-by-page basis. However, since a required part of character data read at each searching operation are provided by dynamically converting it into image data, requirements of clients can be satisfied with flexibility.

The present invention is not limited to the above-described embodiment and may be carried out in the following modes.

1. The server and client terminal of the contents providing system may be used by connecting them to a network utilizing any type of communication means other than the internet such as a public telephone network, CATV, and satellite broadcast.

2. While above description referred to collections of laws, regulations and judicial precedents as examples, the present invention may be advantageously applied to the service of other kinds of character contents such as novels, encyclopedia and dictionaries.

3. While the character data of character contents are stored in a database in the above description, it may be stored in any storage means other than databases such as various files and storage devices.

As described above, in the contents providing system according to the invention, contents are stored in the storage means as character data to maintain operability in character searching using keywords, and character data are transmitted to clients after being converted into image data. This makes it possible to prevent clients from copying and reusing the character data and to thereby prevent any reduction of the value of the character contents as a property. Further, there is no need for maintaining and managing databases for both of character data and image data, and searching requirements of clients can be satisfied with flexibility.

What is claimed is:

1. A method of providing character contents in the form of images, comprising:
(a) a first step of transmitting a request for retrieval of character contents from a client terminal to a contents providing system, the contents providing system and client terminal being connected through a network such that they can communicate with each other;
(b) a second step of searching storage means of the contents providing system to read the requested character contents, the storage means storing the character contents as character data;
(c) a third step of converting the read character contents from character data to image data; and
(d) a fourth step of transmitting the image data as a result of the conversion of the character contents to the client terminal.

2. A method according to claim 1, comprising a step of determining each part of the character contents read from the storage means to see whether it needs to be converted into image data and converting only character data which must be converted into image data.

3. A system for providing character contents in the form of images, comprising:
(a) a contents providing system connected to a client terminal through a network such that they can be communicate with each other;
(b) storage means disposed in a server of the contents providing system for storing character contents as character data;
(c) search means provided at the server for searching the storage means when there is a request for retrieval of character contents from the client terminal to read the requested character contents;
(d) conversion means provided at the server for dynamically converting the read character contents from character data to image data; and
(e) contents information transmission means provided at the server for transmitting the image data as a result of the conversion of the character contents to the client terminal.

4. A system for providing character contents in the form of images according to claim 3, wherein a determination is made on each part of the character contents read from the storage means to see whether it needs to be converted into image data and wherein only character data which must be converted are converted into image data.

5. A system for providing character contents in the form of images according to claim 3, wherein the client terminal and the server of the contents providing system are connected to the internet; a front server and a back server connected to the internet are provided in the server; and a database as the storage means is provided in the back server.

6. A system for providing character contents in the form of images according to claim 5, wherein the search means and conversion means are provided in the front server.

7. A system for providing character contents in the form of images according to claim 3, wherein a WWW server is provided in the server and wherein the contents information transmission means is provided in the WWW server.
